(19) United States
(12) Patent Application Publication
(10) Pub. No.: US 2026/0025767 A1
(43) Pub. Date: Jan. 22, 2026

(54) PATHLOSS OFFSET FOR ASYMMETRIC DL-UL COVERAGE

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US); Dalin Zhu, Allen, TX (US)

(21) Appl. No.: 19/268,893

(22) Filed: Jul. 14, 2025

Related U.S. Application Data
(60) Provisional application No. 63/673,578, filed on Jul. 19, 2024.
(60) Provisional application No. 63/675,478, filed on Jul. 25, 2024.
(60) Provisional application No. 63/718,901, filed on Nov. 11, 2024.
(60) Provisional application No. 63/722,708, filed on Nov. 20, 2024.
(60) Provisional application No. 63/752,365, filed on Jan. 31, 2025.

(51) Int. Cl. H04W 52/24; H04W 52/32; H04W 52/36

(52) U.S. Cl. CPC H04W 52/242; H04W 52/325; H04W 52/365

(57) ABSTRACT

Disclosed are techniques for a UE to use a pathloss offset between the DL pathloss RS from a macro BS/TRP and the actual pathloss for UL transmission to a micro UL-only BS/TRP when reporting power headroom or performing a random access procedure. The UE may receive from a first base station a configuration for one or more pathloss offsets associated with respective one or more TCI states. The UE may determine a pathloss variation toward a second base station between a first pathloss measured at a current time and a second pathloss measured at a previous time based on the one or more pathloss offsets associated with the respective one or more TCI states. The UE may determine that the pathloss variation satisfies a triggering condition for a power headroom report (PHR) for an uplink transmission associated with the TCI states. The UE may trigger a transmission of the PHR.

### CROSS-REFERENCE TO RELATED APPLICATIONS

This application claims the benefit of priority from U.S. Provisional Application No. 63/673,578 entitled “PATHLOSS OFFSET FOR ASYMMETRIC DL-UL COVERAGE,” filed Jul. 19, 2024; U.S. Provisional Application No. 63/675,478 entitled “PATHLOSS OFFSET FOR ASYMMETRIC DL-UL COVERAGE,” filed Jul. 25, 2024; U.S. Provisional Application No. 63/718,901 entitled “PATHLOSS OFFSET FOR ASYMMETRIC DL-UL COVERAGE,” filed Nov. 11, 2024; U.S. Provisional Application No. 63/722,708 entitled “PATHLOSS OFFSET FOR ASYMMETRIC DL-UL COVERAGE,” filed Nov. 20, 2024; and U.S. Provisional Application No. 63/752,365 entitled “PATHLOSS OFFSET FOR ASYMMETRIC DL-UL COVERAGE,” filed Jan. 31, 2025, all which are incorporated herein by reference in their entirety.

### TECHNICAL FIELD

This disclosure relates generally to a wireless communication system, and more particularly to ways for using pathloss offset in asymmetric wireless communication systems in which downlink (DL) communication is between a macro base station and a user equipment and uplink (UL) communication is between the user equipment and a micro base station non-co-located with the macro base station.

### BACKGROUND

5G New Radio (NR) and upcoming technologies currently coined “6G” may deploy a heterogeneous network to improve UL throughput. In one deployment scenario of a heterogenous network, a user equipment (UE) receives DL transmissions from a macro base station (BS) or node (e.g., transmit-receive point (TRP)), but transmits UL to either the macro gNB/TRP or a micro BS/TRP that is not co-located with the macro BS/TRP to maximize UL throughput. As an option to further reduce energy consumption, the micro BS/TRP can, for instance, reduce or even turn off DL transmissions.

Enhancements on UL power control (PC) are needed to support an asymmetric DL/UL BS/TRP deployment scenario where the UE receives DL transmissions from one macro BS/TRP and sends UL transmissions to the micro UL-only BS/TRP. For example, when the macro BS/TRP transmits the DL pathloss reference signals (RS), and the UE measures the reference signal received power (RSRP) to determine the pathloss of the RS from the macro BS/TRP, the pathloss measured from the DL pathloss RS may not reflect the actual pathloss from the UE to the micro BS/TRP. The UE cannot simply rely on the measured DL pathloss for UL PC when the UE transmits UL to the micro BS/TRP. To enhance UL PC, the macro BS/TRP or the micro UL-only BS/TRP may configure the UE with a pathloss offset to facilitate accurate calculation of the pathloss associated with the micro nodes. However, how the UE uses the pathloss offset when reporting power headroom or performing the random access procedure is not clear. It is desired to specify the behavior of the UE for power headroom reporting (PHR) and random access (AC).

While the background section provides a motivation for the present disclosure, the description set forth in the background section should not be assumed to be prior art merely because it is set forth in the background section. Rather, the background section may describe aspects or embodiments of the present disclosure.

### SUMMARY

An aspect of the present disclosure provides for a user equipment (UE) in a wireless network. The UE includes a processor configured to receive from a first base station a configuration for one or more pathloss offsets associated with respective one or more transmission configuration indicator (TCI) states. The processor is also configured to determine a pathloss variation toward a second base station between a first pathloss measured at a current time and a second pathloss measured at a previous time, where the pathloss variation is determined based on the one or more pathloss offsets associated with the respective one or more TCI states. The processor is further configured to determine that the pathloss variation satisfies a triggering condition for a power headroom report (PHR) for an uplink transmission associated with the one or more TCI states. The processor is further configured to trigger a transmission of the PHR.

In one embodiment, to determine the pathloss variation toward the second base station, the processor is configured to determine a first pathloss on a first downlink reference signal associated with a first TCI state from the first base station at the current time; determine a second pathloss on a second downlink reference signal associated with a second TCI state from the first base station at the previous time; and determine the pathloss variation as the difference between the first pathloss and the second pathloss.

In one embodiment, to determine the first pathloss, the processor is configured to set the first pathloss to a measured pathloss on the first downlink reference signal minus the pathloss offset associated with the first TCI state; or set the first pathloss to the measured pathloss on the first downlink reference signal plus the pathloss offset associated with the first TCI state.

In one embodiment, the first downlink reference signal and the second downlink reference signal are either the same downlink reference signal or different downlink reference signals.

In one embodiment, to determine the second pathloss, the processor is configured to set the second pathloss to a measured pathloss on the second downlink reference signal minus the pathloss offset associated with the second TCI state; or set the second pathloss to the measured pathloss on the second downlink reference signal plus the pathloss offset associated with the second TCI state.

In one embodiment, to determine that the pathloss variation satisfies the triggering condition, the processor is configured to receive from the first base station a configuration for a pathloss variation threshold and a PHR timer; determine that the pathloss variation exceeds the pathloss variation threshold; and determine that an elapsed time since a last transmission of the PHR exceeds the PHR timer.

In one embodiment, the uplink transmission comprises a physical uplink shared channel (PUSCH) transmission or a sounding reference signal (SRS) transmission to the second base station.

In one embodiment, the processor is further configured to receive from the first base station a physical downlink control channel (PDCCH) that orders a physical random access channel (PRACH) transmission. The PDCCH includes an indication of a pathloss offset associated with a TCI state. The processor is also configured to determine a transmission power for a PRACH transmission to the second base station based on the pathloss offset.

In one embodiment, the PRACH transmission comprises a contention free random access (CFRA) to the second base station.

In one example, the one or more TCI states include a first TCI state and a second TCI state. The processor is further configured to receive from the first base station an indication to use both the first TCI state and the second TCI state to receive a physical downlink control channel (PDCCH) on a control resource set (CORESET) when a single frequency network scheme is configured for the first base station.

An aspect of the present disclosure provides a method performed by a UE in a wireless network. The method includes the UE receiving from a base station a configuration for one or more pathloss offsets associated with respective one or more TCI states. The method also includes the UE determining a pathloss variation toward a second base station between a first pathloss measured at a current time and a second pathloss measured at a previous time, where the pathloss variation is determined based on the one or more pathloss offsets associated with the respective one or more TCI states. The method further includes the UE determining that the pathloss variation satisfies a triggering condition for a PHR for an uplink transmission associated with the one or more TCI states. The method further includes the UE triggering a transmission of the PHR.

In one embodiment, when determining the pathloss variation toward the second base station, the method includes the UE determining a first pathloss on a first downlink reference signal associated with a first TCI state from the first base station at the current time; the UE determining a second pathloss on a second downlink reference signal associated with a second TCI state from the first base station at the previous time; and the UE determining the pathloss variation as the difference between the first pathloss and the second pathloss.

In one embodiment, when determining the first pathloss, the method includes the UE setting the first pathloss to a measured pathloss on the first downlink reference signal minus the pathloss offset associated with the first TCI state or setting the first pathloss to the measured pathloss on the first downlink reference signal plus the pathloss offset associated with the first TCI state.

In one embodiment of the method, the first downlink reference signal and the second downlink reference signal are either the same downlink reference signal or different downlink reference signals.

In one embodiment, when determining the second pathloss, the method includes the UE setting the second pathloss to a measured pathloss on the second downlink reference signal minus the pathloss offset associated with the second TCI state or setting the second pathloss to the measured pathloss on the second downlink reference signal plus the pathloss offset associated with the second TCI state.

In one embodiment, when determining that the pathloss variation satisfies a triggering condition, the method includes the UE receiving from the first base station a configuration for a pathloss variation threshold and a PHR timer. The method also includes the UE determining that the pathloss variation exceeds the pathloss variation threshold and determining that an elapsed time since a last transmission of the PHR exceeds the PHR timer.

In one embodiment of the method, the uplink transmission comprises a PUSCH transmission or a SRS transmission to the second base station.

In one embodiment, the method further includes the UE receiving from the first base station a PDCCH that orders a PRACH transmission. The PDCCH includes an indication of a pathloss offset associated with a TCI state. The method also includes the UE determining a transmission power for a PRACH transmission to the second base station based on the pathloss offset.

In one embodiment of the method, the PRACH transmission includes a CFRA to the second base station.

In one embodiment, the one or more TCI states includes a first TCI state and a second TCI state. The method further includes the UE receiving from the first base station an indication to use both the first TCI state and the second TCI state to receive a PDCCH on a CORESET when a single frequency network scheme is configured for the first base station.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example of the TCI State Indication for UE-specific PDCCH MAC CE in accordance with an embodiment.

FIG. 5 shows an example of the Enhanced TCI State Indication for UE-specific PDCCH MAC CE in accordance with an embodiment.

FIG. 6 shows an example process 600 for using a pathloss offset between the DL pathloss RS from first base station and the actual pathloss for UL transmission to a base station when reporting power headroom in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic that has dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHZ, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

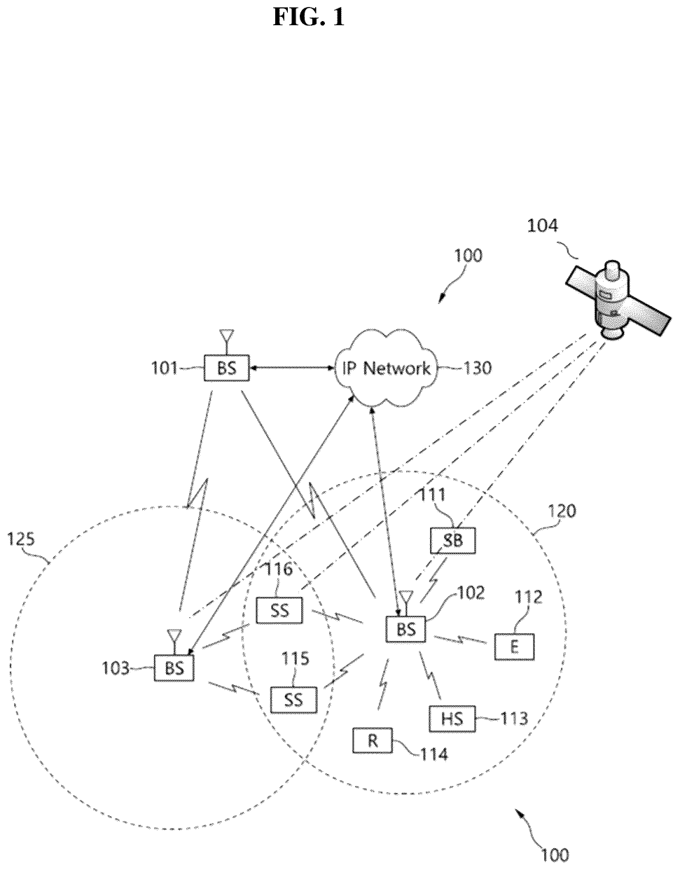

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the BS 101, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

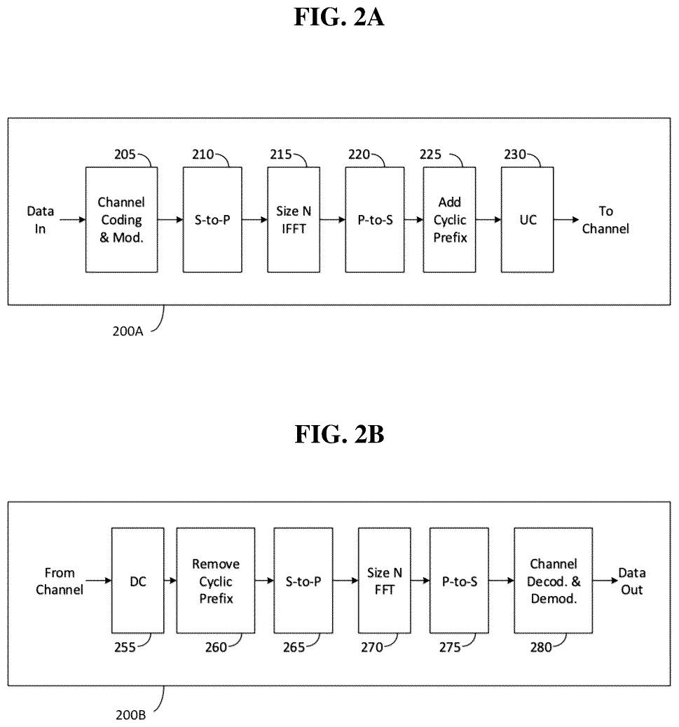

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

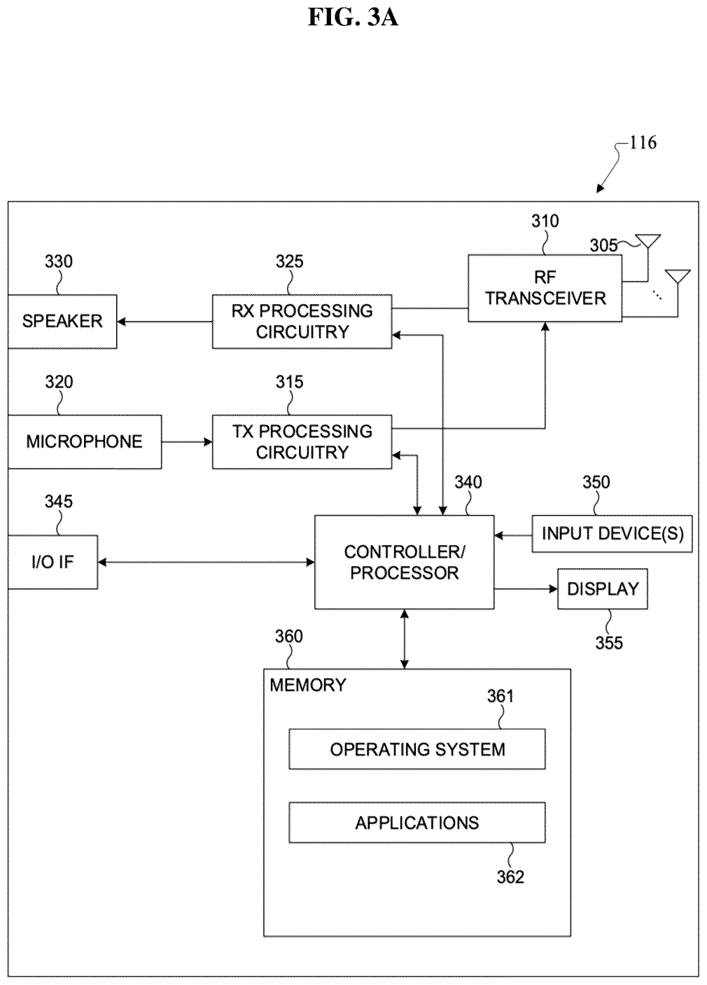

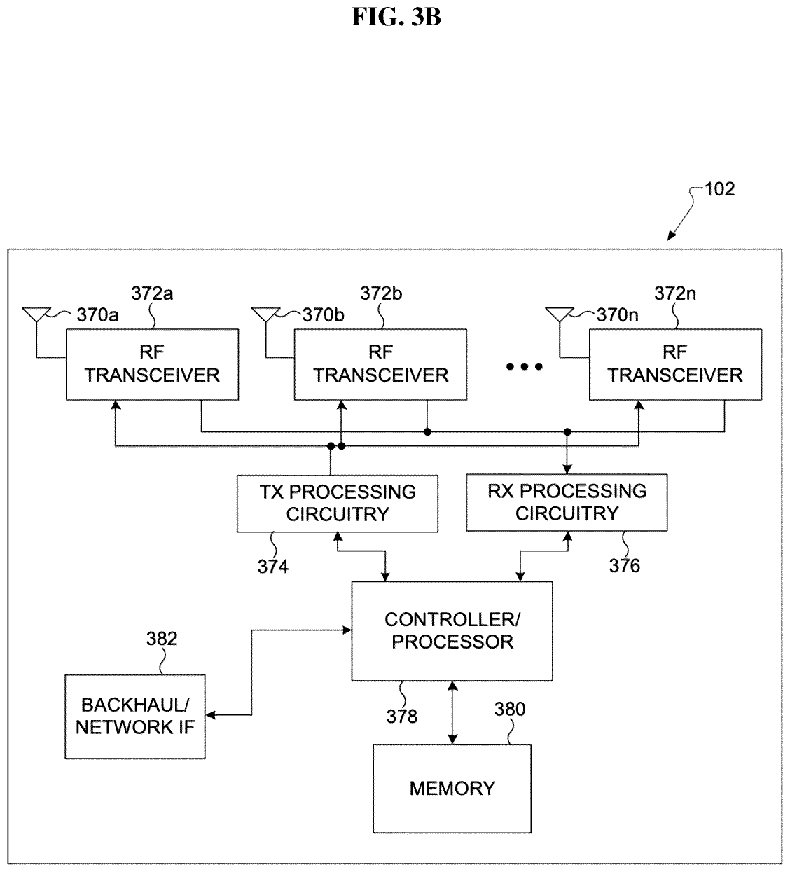

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 is coupled to the processor 340, directly or through intervening elements. The main processor 340 is also capable of executing other processes and programs resident in the memory 360 as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main processor 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3 A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting other processes in wireless communication systems as described in embodiments of the present disclosure. In some embodiments, the controller/processor 378 supports communications between entities, such as web real-time communication (web RTC). The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning the uplink transmission to a certain frequency and establishing the downlink transmission using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one TX processing circuitry 374 or RX processing circuitry 376 per RF transceiver).

As an example, Release 13 of the LTE standard supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For 5G and the next generation cellular systems such as 6G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms may be formulated by the inventors and designed to assist in providing an efficient description of the unique features within the disclosure. A list of both common and unique acronyms follows.

The following documents are hereby incorporated by reference in their entirety into the present disclosure as if fully set forth herein: i) 3GPP TS 38.300 v18,1.0; ii) 3GPP TS 38.331 v18.1.0; and iii) 3GPP TS 38.321 v18.1.0.

Disclosed are techniques for a UE to use a pathloss offset between the DL pathloss RS from a macro BS/TRP and the actual pathloss for UL transmission to a micro UL-only BS/TRP when reporting power headroom or performing a random access (RA) procedure.

In one embodiment, a UE may receive a configuration for a pathloss offset (e.g., PLoffset-RACH) and/or a RSRP offset (e.g., RSRPoffset-RACH) through RA resource configuration by RRC. In one embodiment, a pathloss offset and/or a RSRP offset may be associated with a RA resource configuration. If a pathloss offset and/or a RSRP offset is configured or associated with a RA resource configuration, the UE applies the pathloss offset and/or the RSRP offset to determine the UL power for physical random access channel (PRACH) transmission. For example, if a pathloss offset and/or a RSRP offset is configured or associated with a RA resource configuration, the UE may apply the pathloss offset and/or the RSRP offset in the RA procedure (e.g., apply the pathloss offset and/or the RSRP offset to determine the RSRP of DL pathloss RS or to determine the RSRP threshold used in selection of normal uplink (NUL) or supplementary uplink (SUL) carrier, and/or in selection of 4-step RA or 2-step RA, and/or in Msg1 repetition, and/or in Msg3 repetition, and/or in selection of preamble group A or preamble group B).

In one embodiment, a pathloss offset (e.g., namely, PLoffset-RACH) and/or a RSRP offset (e.g., namely, RSRPoffset-RACH) is configured in transmission configuration indication (TCI) state configuration or is configured for a synchronization signal block (SSB). In one embodiment, a pathloss offset and/or a RSRP offset is associated with a joint TCI state and/or a UL TCI state and/or a SSB. The UE may select an SSB associated with a PRACH occasion or the UE may receive an indication of SSB index in downlink control information (DCI) format in physical downlink control channel (PDCCH) that orders RACH.

In one example, the UE selects a joint TCI state or a UL TCI state that is quasi-co-located with the selected/indicated SSB (i.e., the selected/indicated SSB is the RS in the associated QCL-information configuration of the TCI state), and the UE transmits PRACH using the selected joint TCI state or UL TCI state that is quasi-co-located with the selected/indicated SSB (i.e., the selected/indicated SSB is the RS in the associated QCL-info configuration of the TCI state). In a second example, the UE receives an indication of a joint TCI state or an UL TCI state for PRACH transmission (e.g., the indication can be in DCI format in PDCCH-ordered RACH) or the UE selects a joint TCI state or an UL TCI state by implementation for PRACH transmission. The UE then transmits PRACH using the indicated/selected joint TCI state or UL TCI state. If a pathloss offset and/or a RSRP offset is configured for this TCI state (or for the selected/indicated SSB) used for PRACH transmission, the UE applies the pathloss offset to determine UL power for PRACH transmission. For example, if a pathloss offset and/or a RSRP offset is configured for this TCI state (or for the selected/indicated SSB) used for PRACH transmission, UE may apply the pathloss offset and/or the RSRP offset in the RA procedure (e.g., apply the pathloss offset and/or the RSRP offset to determine the RSRP of DL pathloss RS or to determine the RSRP threshold used in selection of NUL or SUL, and/or in selection of 4-step RA or 2-step RA, and/or in Msg1 repetition, and/or in Msg3 repetition, and/or in selection of preamble group A or preamble group B).

In one embodiment, a pathloss offset and/or a RSRP offset between the DL pathloss RS from the macro BS/TRP and the actual pathloss for UL transmission to a micro UL-only BS/TRP is only applied for PDCCH-ordered contention free random access or contention based random access (CFRA/CBRA).

For example, the UE may receive a configuration for a pathloss offset (e.g., namely, PLoffset-RACH) and/or a RSRP offset (e.g., namely, RSRPoffset-RACH) in RA resource configuration. If the UE receives a DCI format in PDCCH that orders CFRA/CBRA and if a pathloss offset and/or a RSRP offset is configured in the RACH configuration and/or in TCI state configuration and/or indicated in the DCI format, the UE applies the pathloss offset to determine UL power for PRACH transmission. For example, if the UE receives a DCI format in PDCCH that orders CFRA/CBRA and if a pathloss offset and/or a RSRP offset is configured in the RACH configuration and/or in TCI state configuration and/or indicated in the DCI format, the UE may apply the pathloss offset and/or the RSRP offset to determine the RSRP of DL pathloss RS or to determine the RSRP threshold used in selection of NUL or SUL, and/or in selection of 4-step RA or 2-step RA, and/or in Msg1 repetition, and/or in Msg3 repetition, and/or in selection of preamble group A or preamble group B.

For another example, a pathloss offset (e.g., namely, PLoffset-RACH) and/or a RSRP offset (e.g., namely, RSRPoffset-RACH) is configured in TCI state configuration or is configured for a SSB. In one embodiment, a pathloss offset and/or a RSRP offset is associated with a joint TCI state and/or a UL TCI state and/or a SSB. In one example, the UE receives a DCI format in PDCCH that orders CFRA/CBRA, where an SSB index is indicated in the DCI format, and the UE transmits PRACH using a joint TCI state or a UL TCI state that is quasi-co-located with the indicated SSB (i.e., the indicated SSB is the RS in the associated QCL-info configuration of the TCI state). In another example, the UE receives a DCI format in PDCCH that orders CFRA/CBRA, where a joint TCI state or an UL TCI state is indicated in the DCI format, and the UE transmits PRACH using the indicated joint TCI state or UL TCI state. In one more example, the UE receives a DCI format in PDCCH that orders CFRA/CBRA, and the UE transmits PRACH using a joint TCI state or UL TCI state that is selected by implementation. If a pathloss offset and/or a RSRP offset is configured for this TCI state (or for the indicated SSB) used for PRACH transmission, the UE applies the pathloss offset and/or the RSRP offset to determine UL power for PRACH transmission. For example, if a pathloss offset and/or a RSRP offset is configured for this TCI state (or for the indicated SSB) used for PRACH transmission, the UE may apply the pathloss offset and/or the RSRP offset to determine the RSRP of DL pathloss RS or to determine the RSRP threshold used in selection of NUL or SUL, and/or in selection of 4-step RA or 2-step RA, and/or in Msg1 repetition, and/or in Msg3 repetition, and/or in selection of preamble group A or preamble group B.

In one embodiment, the UE may receive configurations for multiple pathloss offsets and/or multiple RSRP offsets. Each pathloss offset and/or each RSRP offset may be dedicatedly used to determine the RSRP of DL pathloss RS or the RSRP threshold used in selection of NUL or SUL, or in selection of 4-step RA or 2-step RA, or in Msg1 repetition, or in Msg3 repetition, or in selection of preamble group A or preamble group B.

In one embodiment, the UE may receive a RSRP threshold instead of, or in addition to, the RSRP offset. In one embodiment, the UE may receive configurations for one or multiple RSRP thresholds in RACH configuration and/or in TCI state configuration and/or indicated in a DCI format for the asymmetric DL/UL BS/TRP scenario. For example, for the asymmetric DL/UL BS/TRP scenario, UE receives one or multiple RSRP thresholds in RACH configuration and/or in TCI state configuration and/or in a DCI format, where each RSRP threshold is dedicatedly configured to compare with the measured RSRP of DL pathloss RS used in selection of NUL or SUL, or in selection of 4-step RA or 2-step RA, or in Msg1 repetition, or in Msg3 repetition, or in selection of preamble group A or preamble group B.

In one embodiment, when applying the common RSRP offset (i.e., RSRPoffset-RACH), the UE may apply rsrp-ThresholdSSB-SUL plus or minus RSRPoffset-RACH for the selection between SUL and NUL, and/or apply msgA-RSRP-Threshold plus or minus RSRPoffset-RACH for the selection between 4-step RA and 2-step RA, and/or apply rsrp-ThresholdMsg1-RepetitionNum8/4/2/X plus or minus RSRPoffset-RACH for Msg1 repetition, and/or apply rsrp-ThresholdMsg3 plus or minus RSRPoffset-RACH for Msg3 repetition.

In one embodiment, when applying the dedicated RSRP offsets, the UE may apply rsrp-ThresholdSSB-SUL plus or minus RSRPoffset-RACH-SUL for the selection between SUL and NUL, and/or apply msgA-RSRP-Threshold plus or minus RSRPoffset-RACH-type for the selection between 4-step RA and 2-step RA, and/or apply rsrp-ThresholdMsg1-RepetitionNum8/4/2/X plus or minus RSRPoffset-RACH-Msg1 for Msg1 repetition, and/or apply rsrp-ThresholdMsg3 plus or minus RSRPoffset-RACH-Msg3 for Msg3 repetition.

In one embodiment, a base station may transmit a dedicated RACH resource configuration per bandwidth part (BWP) per cell for the scenario of asymmetric DL-UL BS/TRP coverage. For example, the base station configures a set of values for RSRP thresholds (e.g., rsrp-ThresholdSSB-SUL for the selection between SUL and NUL, and/or msgA-RSRP-Threshold for the selection between 4-step RA and 2-step RA, and/or rsrp-ThresholdMsg1-RepetitionNum8/4/2/X for Msg1 repetition, and/or rsrp-ThresholdMsg3 for Msg3 repetition) in the RACH resource configuration to enable the UE to take into account the pathloss difference between the DL pathloss RS from the macro BS/TRP and the actual pathloss for UL transmission to a micro UL-only BS/TRP for the RA procedure.

In one embodiment, if the UE select a RACH resource that is associated with a dedicated configuration for the asymmetric DL-UL BS/TRP coverage, the UE applies the configuration including the RSRP thresholds for the RA procedure. In one embodiment, the UE may receive an indication from the base station that indicates the asymmetric DL-UL coverage (e.g., explicitly by an indication or implicitly by a parameter, for example a pathloss/RSRP offset). The indication may be included in the DCI format in PDCCH-ordered RACH. Then, the UE applies the dedicated RACH resource configuration for the RA procedure.

In one embodiment, when the UE selects between NUL and SUL in the RA procedure, the UE performs as follows when a RSRP threshold (e.g., rsrp-ThresholdSSB-SUL-Asymm) or pathloss/RSRP offset (e.g., PL-Offset or RSRPoffset-RACH) is configured/indicated (e.g., in RA resource configuration and/or in TCI state configuration and/or indicated in a DCI format) and the UE applies the RSRP threshold in RA procedure for asymmetric DL/UL BS/TRP scenario:

| 1> | if PL-Offset or RSRPoffset-RACH is configured/indicated/applied (e.g., in RA resource | | |
|---|---|---|---|
| | configuration and/or in TCI state configuration and/or indicated in a DCI format): | | |
| | 2> | if the RSRP of the downlink pathloss reference is less than rsrp-ThresholdSSB-SUL − | |
| | | (or + in another example) PL-Offset (or RSRPoffset-RACH): | |
| | 2> | | select the SUL carrier for performing Random Access procedure; |
| | 2> | | set the PCMAX to P_{CMAX,f,c} of the SUL carrier. |

| | |
|---|---|
| 2> | else: |

| | |
|---|---|
| 3> | select the NUL carrier for performing Random Access procedure; |
| 3> | set the PCMAX to P_{CMAX,f,c} of the NUL carrier. |

| 1> | else if the RSRP of the downlink pathloss reference is less than rsrp-ThresholdSSB-SUL- | |
|---|---|---|
| | Asymm; or | |
| 1> | if the RSRP of the downlink pathloss reference is less than rsrp-ThresholdSSB-SUL: | |
| | 2> | select the SUL carrier for performing Random Access procedure; |
| | 2> | set the PCMAX to P_{CMAX,f,c} of the SUL carrier. |
| 1> | else: | |
| | 2> | select the NUL carrier for performing Random Access procedure; |
| | 2> | set the PCMAX to P_{CMAX,f,c} of the NUL carrier. |

In one embodiment, when the UE selects between 4-step RA and 2-step RA, the UE performs as follows when a RSRP threshold (e.g., msgA-RSRP-Threshold-Asymm) or pathloss/RSRP offset (e.g., PL-Offset or RSRPoffset-RACH) is configured/indicated (e.g., in RA resource configuration and/or in TCI state configuration and/or indicated in a DCI format) and the UE applies the RSRP threshold in RA procedure for asymmetric DL/UL BS/TRP scenario:

| 1> | if the BWP selected for Random Access procedure is configured with both 2-step and 4- | |
|---|---|---|
| | step RA type Random Access Resources within the selected set of Random Access | |
| | resources (as specified in 3GPP TS 38.321 clause 5.1.1b): | |
| | 2> | if PL-Offset or RSRPoffset-RACH is configured/indicated/applied (e.g., in RA resource |

configuration and/or in TCI state configuration and/or indicated in a DCI format):

| | |
|---|---|
| 3> | if the RSRP of the downlink pathloss reference is above msgA-RSRP-Threshold − |

(or + in another example) PL-Offset (or RSRPoffset-RACH):

| | |
|---|---|
| 4> | set the RA_TYPE to 2-stepRA. |

| | |
|---|---|
| 3> | else: |

| | |
|---|---|
| 4> | set the RA_TYPE to 4-stepRA. |

| | |
|---|---|
| 2> | else if the RSRP of the downlink pathloss reference is above msgA-RSRP-Threshold- |
| | Asymm; or |
| 2> | if the RSRP of the downlink pathloss reference is above msgA-RSRP-Threshold: |

| | |
|---|---|
| 3> | set the RA_TYPE to 2-stepRA. |

| | |
|---|---|
| 2> | else: |

| | |
|---|---|
| 3> | set the RA_TYPE to 4-stepRA |

In one embodiment, when the UE determines the Msg1 repetition, the UE performs as follows when RSRP threshold(s) (e.g., rsrp-ThresholdMsg1-RepetitionNum8/4/2/X-Asymm) or pathloss/RSRP offset (e.g., PL-Offset or RSRPoffset-RACH) is configured/indicated (e.g., in RA resource configuration and/or in TCI state configuration and/or indicated in a DCI format) and the UE applies the RSRP threshold(s) in RA procedure for asymmetric DL/UL BS/TRP scenario:

| 1> | if contention free Random Access Resources have not been provided for this Random | | |
|---|---|---|---|
| | Access procedure and the BWP selected for the Random Access procedure is configured | | |
| | with set(s) of Random Access resources with msg1-Repetitions set to true and set(s) of | | |
| | Random Access resources without msg1-Repetitions set to true: | | |
| | 2> | if PL-Offset or RSRPoffset-RACH is configured/indicated/applied (e.g., in RA resource | |
| | | configuration and/or in TCI state configuration and/or indicated in a DCI format): | |
| | 3> | | if the BWP selected for the Random Access procedure is configured with set(s) of |
| | | | Random Access resources associated with Msg1 repetition number 8 and the RSRP of |
| | | | the downlink pathloss reference is less than rsrp-ThresholdMsg1-RepetitionNum8 − |
| | | | (or + in another example) PL-Offset (or RSRPoffset-RACH): |

| | |
|---|---|
| 4> | assume Msg1 repetition is applicable and Msg1 repetition number applicable for |
| | the current Random Access procedure includes 8. |

| | |
|---|---|
| 3> | if the BWP selected for the Random Access procedure is configured with set(s) of |
| | Random Access resources associated with Msg1 repetition number 4 and the RSRP of |
| | the downlink pathloss reference is less than rsrp-ThresholdMsg1-RepetitionNum4 − |
| | (or + in another example) PL-Offset (or RSRPoffset-RACH): |

| | |
|---|---|
| 4> | assume Msg1 repetition is applicable and Msg1 repetition number applicable for |
| | the current Random Access procedure includes 4. |

| | |
|---|---|
| 3> | if the BWP selected for the Random Access procedure is configured with set(s) of |
| | Random Access resources associated with Msg1 repetition number 2 and the RSRP of |
| | the downlink pathloss reference is less than rsrp-ThresholdMsg1-RepetitionNum2 − |
| | (or + in another example) PL-Offset (or RSRPoffset-RACH): |

| | |
|---|---|
| 4> | assume Msg1 repetition is applicable and Msg1 repetition number applicable for |
| | the current Random Access procedure includes 2. |

| | |
|---|---|
| 3> | else if the RSRP of the downlink pathloss reference is not less than any configured |
| | rsrp-ThresholdMsg1-RepetitionNumX − (or + in another example) PL-Offset (or |
| | RSRPoffset-RACH): |

| | |
|---|---|
| 4> | assume Msg1 repetition is not applicable for the current Random Access procedure. |

| 2> | else if at least one of rsrp-ThresholdMsg1-RepetitionNumX-Asymm is | |
|---|---|---|
| | configured/indicated/applied: | |
| 3> | | if the BWP selected for the Random Access procedure is configured with set(s) of |
| | | Random Access resources associated with Msg1 repetition number 8 and the RSRP of |
| | | the downlink pathloss reference is less than rsrp-ThresholdMsg1-RepetitionNum8- |
| | | Asymm: |

| | |
|---|---|
| 4> | assume Msg1 repetition is applicable and Msg1 repetition number applicable for |
| | the current Random Access procedure includes 8. |

| | |
|---|---|
| 3> | if the BWP selected for the Random Access procedure is configured with set(s) of |
| | Random Access resources associated with Msg1 repetition number 4 and the RSRP of |
| | the downlink pathloss reference is less than rsrp-ThresholdMsg1-RepetitionNum4- |
| | Asymm: |

| | |
|---|---|
| 4> | assume Msg1 repetition is applicable and Msg1 repetition number applicable for |
| | the current Random Access procedure includes 4. |

| | |
|---|---|
| 3> | if the BWP selected for the Random Access procedure is configured with set(s) of |
| | Random Access resources associated with Msg1 repetition number 2 and the RSRP of |
| | the downlink pathloss reference is less than rsrp-ThresholdMsg1-RepetitionNum2- |
| | Asymm: |

| | |
|---|---|
| 4> | assume Msg1 repetition is applicable and Msg1 repetition number applicable for |
| | the current Random Access procedure includes 2. |

| | |
|---|---|
| 3> | else if the RSRP of the downlink pathloss reference is not less than any configured |
| | rsrp-ThresholdMsg1-RepetitionNumX-Asymm: |

| | |
|---|---|
| 4> | assume Msg1 repetition is not applicable for the current Random Access procedure. |

| 2> | else: | |
|---|---|---|
| 3> | | if the BWP selected for the Random Access procedure is configured with set(s) of |
| | | Random Access resources associated with Msg1 repetition number 8 and the RSRP of |
| | | the downlink pathloss reference is less than rsrp-ThresholdMsg1-RepetitionNum8: |

| | |
|---|---|
| 4> | assume Msg1 repetition is applicable and Msg1 repetition number applicable for |
| | the current Random Access procedure includes 8. |

| | |
|---|---|
| 3> | if the BWP selected for the Random Access procedure is configured with set(s) of |
| | Random Access resources associated with Msg1 repetition number 4 and the RSRP of |
| | the downlink pathloss reference is less than rsrp-ThresholdMsg1-RepetitionNum4: |

| | |
|---|---|
| 4> | assume Msg1 repetition is applicable and Msg1 repetition number applicable for |
| | the current Random Access procedure includes 4. |

| | |
|---|---|
| 3> | if the BWP selected for the Random Access procedure is configured with set(s) of |
| | Random Access resources associated with Msg1 repetition number 2 and the RSRP of |
| | the downlink pathloss reference is less than rsrp-ThresholdMsg1-RepetitionNum2: |

| | |
|---|---|
| 4> | assume Msg1 repetition is applicable and Msg1 repetition number applicable for |
| | the current Random Access procedure includes 2. |

| | |
|---|---|
| 3> | else if the RSRP of the downlink pathloss reference is not less than any configured |
| | rsrp-ThresholdMsg1-RepetitionNumX: |

| | |
|---|---|
| 4> | assume Msg1 repetition is not applicable for the current Random Access procedure. |

| 1> | else if the BWP selected for Random Access procedure is configured only with Random | |
|---|---|---|
| | Access resources with msg1-Repetitions set to true: | |
| | 2> | assume Msg1 repetition is applicable for the current Random Access procedure; |
| | 2> | if at least one of rsrp-ThresholdMsg1-RepetitionNumX is configured and if PL-Offset or |
| | | RSRPoffset-RACH is configured/indicated/applied (e.g., in RA resource configuration |
| | | and/or in TCI state configuration and/or indicated in a DCI format): |

| | |
|---|---|
| 3> | if rsrp-ThresholdMsg1-RepetitionNum8 is configured and the RSRP of the downlink |
| | pathloss reference is less than rsrp-ThresholdMsg1-RepetitionNum8 − (or + in |
| | another example) PL-Offset (or RSRPoffset-RACH); |

| | |
|---|---|
| 4> | assume Msg1 repetition number applicable for the current Random Access |
| | procedure includes 8. |

| | |
|---|---|
| 3> | if rsrp-ThresholdMsg1-RepetitionNum4 is configured and the RSRP of the downlink |
| | pathloss reference is less than rsrp-ThresholdMsg1-RepetitionNum4 − (or + in |
| | another example) PL-Offset (or RSRPoffset-RACH): |

| | |
|---|---|
| 4> | assume Msg1 repetition number applicable for the current Random Access |
| | procedure includes 4. |

| | |
|---|---|
| 3> | if rsrp-ThresholdMsg1-RepetitionNum2 is configured and the RSRP of the downlink |
| | pathloss reference is less than rsrp-ThresholdMsg1-RepetitionNum2 − (or + in |
| | another example) PL-Offset (or RSRPoffset-RACH): |

| | |
|---|---|
| 4> | assume Msg1 repetition number applicable for the current Random Access |
| | procedure includes 2. |

| | |
|---|---|
| 3> | else if the RSRP of the downlink pathloss reference is not less than any configured |
| | rsrp-ThresholdMsg1-RepetitionNumX − (or + in another example) PL-Offset (or |
| | RSRPoffset-RACH): |

| | |
|---|---|
| 4> | assume Msg1 repetition number applicable for the current Random Access |
| | procedure is the lowest Msg1 repetition number configured for this BWP. |

| | |
|---|---|
| 2> | else if at least one of rsrp-ThresholdMsg1-RepetitionNumX-Asymm is configured: |

| | |
|---|---|
| 3> | if rsrp-ThresholdMsg1-RepetitionNum8-Asymm is configured and the RSRP of the |
| | downlink pathloss reference is less than rsrp-ThresholdMsg1-RepetitionNum8- |
| | Asymm; |

| | |
|---|---|
| 4> | assume Msg1 repetition number applicable for the current Random Access |
| | procedure includes 8. |

| | |
|---|---|
| 3> | if rsrp-ThresholdMsg1-RepetitionNum4-Asymm is configured and the RSRP of the |
| | downlink pathloss reference is less than rsrp-ThresholdMsg1-RepetitionNum4- |
| | Asymm: |

| | |
|---|---|
| 4> | assume Msg1 repetition number applicable for the current Random Access |
| | procedure includes 4. |

| | |
|---|---|
| 3> | if rsrp-ThresholdMsg1-RepetitionNum2-Asymm is configured and the RSRP of the |
| | downlink pathloss reference is less than rsrp-ThresholdMsg1-RepetitionNum2- |
| | Asymm: |

| | |
|---|---|
| 4> | assume Msg1 repetition number applicable for the current Random Access |
| | procedure includes 2. |

| | |
|---|---|
| 3> | else if the RSRP of the downlink pathloss reference is not less than any configured |
| | rsrp-ThresholdMsg1-RepetitionNumX-Asymm: |

| | |
|---|---|
| 4> | assume Msg1 repetition number applicable for the current Random Access |
| | procedure is the lowest Msg1 repetition number configured for this BWP. |

| | |
|---|---|
| 2> | else if at least one of rsrp-ThresholdMsg1-RepetitionNumX is configured: |

| | |
|---|---|
| 3> | if rsrp-ThresholdMsg1-RepetitionNum8 is configured and the RSRP of the downlink |
| | pathloss reference is less than rsrp-ThresholdMsg1-RepetitionNum8; |

| | |
|---|---|
| 4> | assume Msg1 repetition number applicable for the current Random Access |
| | procedure includes 8. |

| | |
|---|---|
| 3> | if rsrp-ThresholdMsg1-RepetitionNum4 is configured and the RSRP of the downlink |
| | pathloss reference is less than rsrp-ThresholdMsg1-RepetitionNum4: |

| | |
|---|---|
| 4> | assume Msg1 repetition number applicable for the current Random Access |
| | procedure includes 4. |

| | |
|---|---|
| 3> | if rsrp-ThresholdMsg1-RepetitionNum2 is configured and the RSRP of the downlink |
| | pathloss reference is less than rsrp-ThresholdMsg1-RepetitionNum2: |

| | |
|---|---|
| 4> | assume Msg1 repetition number applicable for the current Random Access |
| | procedure includes 2. |

| | |
|---|---|
| 3> | else if the RSRP of the downlink pathloss reference is not less than any configured |
| | rsrp-ThresholdMsg1-RepetitionNumX: |

| | |
|---|---|
| 4> | assume Msg1 repetition number applicable for the current Random Access |
| | procedure is the lowest Msg1 repetition number configured for this BWP. |

| | |
|---|---|
| 2> | else: |
| 3> | assume Msg1 repetition number applicable for the current Random Access procedure is |
| | the Msg1 repetition number that configured for this BWP. |

In one embodiment, for PDCCH-ordered CFRA/CBRA, Msg1 repetition is not applicable for PDCCH-ordered CFRA/CBRA when a pathloss offset (e.g., namely, PLoffset-RACH) or a RSRP offset (e.g., namely, RSRPoffset-RACH) is configured (e.g., in RA resource configuration and/or in TCI state configuration and/or indicated in a DCI format). The UE performs the RA procedure for asymmetric DL/UL BS/TRP scenario as follows:

| 1> | if the BWP selected for Random Access procedure is configured only with Random Access | | |
|---|---|---|---|
| | resources with msg1-Repetitions set to true: | | |
| | 2> | | if the Random Access procedure is initiated by PDCCH order and if the ra- |
| | | | PreambleIndex explicitly provided by PDCCH is not 0b000000 and if PLoffset-RACH |
| | | | or RSRPoffset-RACH is configured (e.g., in RA resource configuration and/or in TCI |
| | | | state configuration and/or indicated in a DCI format); or |
| | 2> | | if the Random Access procedure is initiated by PDCCH order and if the ra- |
| | | | PreambleIndex explicitly provided by PDCCH is 0b000000 and if PLoffset-RACH or |
| | | | RSRPoffset-RACH is configured (e.g., in RA resource configuration and/or in TCI state |
| | | | configuration and/or indicated in a DCI format): |
| | | 2> | assume Msg1 repetition is not applicable for the current Random Access procedure; |
| | 2> | | else: |
| | 2> | | assume Msg1 repetition is applicable for the current Random Access procedure. |

In one embodiment, in Msg1 repetition for system information (SI) request, the UE performs as follows when RSRP threshold(s) (e.g., rsrp-ThresholdMsg1-RepetitionNum8/4/2-Asymm) or pathloss/RSRP offset (e.g., PL-Offset or RSRPoffset-RACH) is configured/indicated (e.g., in RA resource configuration and/or in TCI state configuration and/or indicated in a DCI format) and the UE applies the RSRP threshold(s) in RA procedure for asymmetric DL/UL BS/TRP scenario:

| 1> | if PL-Offset or RSRPoffset-RACH is configured/indicated/applied (e.g., in RA resource | |
|---|---|---|
| | configuration and/or in TCI state configuration and/or indicated in a DCI format): | |
| | 2> | if si-RequestResourcesRepetitionNum8 is configured and the RSRP of the downlink |
| | | pathloss reference is less than rsrp-ThresholdMsg1-RepetitionNum8 − (or + in another |
| | | example) PL-Offset (or RSRPoffset-RACH): |

| | |
|---|---|
| 3> | criteria to apply Msg1 repetition for SI request is considered met and Msg1 repetition |
| | number applicable is 8. |

| | |
|---|---|
| 2> | else if si-RequestResourcesRepetitionNum4 is configured and the RSRP of the downlink |
| | pathloss reference is less than rsrp-ThresholdMsg1-RepetitionNum4 − (or + in another |
| | example) PL-Offset (or RSRPoffset-RACH): |

| | |
|---|---|
| 3> | criteria to apply Msg1 repetition for SI request is considered met and Msg1 repetition |
| | number applicable is 4. |

| | |
|---|---|
| 2> | else si-RequestResourcesRepetitionNum2 is configured and the RSRP of the downlink |
| | pathloss reference is less than rsrp-ThresholdMsg1-RepetitionNum2 − (or + in another |
| | example) PL-Offset (or RSRPoffset-RACH): |

| | |
|---|---|
| 3> | criteria to apply Msg1 repetition for SI request is considered met and Msg1 repetition |
| | number applicable is 2. |

| 1> | else if at least one of rsrp-ThresholdMsg1-RepetitionNumX-Asymm is | |
|---|---|---|
| | configured/indicated/applied: | |
| | 2> | if si-RequestResourcesRepetitionNum8 is configured and the RSRP of the downlink |
| | | pathloss reference is less than rsrp-ThresholdMsg1-RepetitionNum8-Asymm: |

| | |
|---|---|
| 3> | criteria to apply Msg1 repetition for SI request is considered met and Msg1 repetition |
| | number applicable is 8. |

| | |
|---|---|
| 2> | else if si-RequestResourcesRepetitionNum4 is configured and the RSRP of the downlink |
| | pathloss reference is less than rsrp-ThresholdMsg1-RepetitionNum4-Asymm: |

| | |
|---|---|
| 3> | criteria to apply Msg1 repetition for SI request is considered met and Msg1 repetition |
| | number applicable is 4. |

| | |
|---|---|
| 2> | else si-RequestResourcesRepetitionNum2 is configured and the RSRP of the downlink |
| | pathloss reference is less than rsrp-ThresholdMsg1-RepetitionNum2-Asymm: |

| | |
|---|---|
| 3> | criteria to apply Msg1 repetition for SI request is considered met and Msg1 repetition |
| | number applicable is 2. |

| 1> | else: | |
|---|---|---|
| | 2> | if si-RequestResourcesRepetitionNum8 is configured and the RSRP of the downlink |
| | | pathloss reference is less than rsrp-ThresholdMsg1-RepetitionNum8: |

| | |
|---|---|
| 3> | criteria to apply Msg1 repetition for SI request is considered met and Msg1 repetition |
| | number applicable is 8. |

| | |
|---|---|
| 2> | else if si-RequestResourcesRepetitionNum4 is configured and the RSRP of the downlink |
| | pathloss reference is less than rsrp-ThresholdMsg1-RepetitionNum4: |

| | |
|---|---|
| 3> | criteria to apply Msg1 repetition for SI request is considered met and Msg1 repetition |
| | number applicable is 4. |

| | |
|---|---|
| 2> | else si-RequestResourcesRepetitionNum2 is configured and the RSRP of the downlink |
| | pathloss reference is less than rsrp-ThresholdMsg1-RepetitionNum2: |

| | |
|---|---|
| 3> | criteria to apply Msg1 repetition for SI request is considered met and Msg1 repetition. |
| | number applicable is 2. |

In one embodiment, for PDCCH-ordered CFRA/CBRA, Msg1 repetition for SI request is not applicable for PDCCH-ordered CFRA/CBRA when a pathloss offset (e.g., namely, PLoffset-RACH) or a RSRP offset (e.g., namely, RSRPoffset-RACH) is configured in RA resource configuration and/or in TCI state configuration and/or indicated in a DCI format.

In one embodiment, in Msg3 repetition, the UE performs as follows when RSRP threshold(s) (e.g., rsrp-ThresholdMsg3-Asymm) or RSRP offset (e.g., PL-Offset or RSRPoffset-RACH) is configured/indicated (e.g., in RA resource configuration and/or in TCI state configuration and/or indicated in a DCI format) and the UE applies the RSRP threshold(s) in RA procedure for asymmetric DL/UL BS/TRP scenario:

| 1> | if the BWP selected for Random Access procedure is configured with both set(s) of | |
|---|---|---|
| | Random Access resources with msg3-Repetitions set to true and set(s) of Random Access | |
| | resources without msg3-Repetitions set to true: | |
| | 2> | if PL-Offset or RSRPoffset-RACH is configured/indicated/applied (e.g., in RA resource |
| | | configuration and/or in TCI state configuration and/or indicated in a DCI format): |

| | |
|---|---|
| 3> | if the RSRP of the downlink pathloss reference is less than rsrp-ThresholdMsg3 − (or |
| | + in another example) PL-Offset (or RSRPoffset-RACH); |

| | |
|---|---|
| 4> | assume Msg3 repetition is applicable for the current Random Access procedure. |

| | |
|---|---|
| 3> | else; |

| | |
|---|---|
| 4> | assume Msg3 repetition is not applicable for the current Random Access procedure. |

| | |
|---|---|
| 2> | else if the RSRP of the downlink pathloss reference is less than rsrp-ThresholdMsg3- |
| | Asymm; or |
| 2> | if the RSRP of the downlink pathloss reference is less than rsrp-ThresholdMsg3; |

| | |
|---|---|
| 3> | assume Msg3 repetition is applicable for the current Random Access procedure. |

| 1> | else if the BWP selected for Random Access procedure is only configured with the set(s) | |
|---|---|---|
| | of Random Access resources with msg3-Repetitions set to true: | |
| | 2> | assume Msg3 repetition is applicable for the current Random Access procedure. |
| 1> | else: | |
| | 2> | assume Msg3 repetition is not applicable for the current Random Access procedure. |

In one embodiment, for PDCCH-ordered CFRA/CBRA, Msg3 repetition is not applicable for PDCCH-ordered CFRA/CBRA when a pathloss offset (e.g., namely, PLoffset-RACH) or a RSRP offset (e.g., namely, RSRPoffset-RACH) is configured (e.g., in RA resource configuration and/or in TCI state configuration and/or indicated in a DCI format). The UE performs the RA procedure for asymmetric DL/UL BS/TRP scenario as follows:

| 1> | if the Random Access procedure is initiated by PDCCH order and if the ra-PreambleIndex | |
|---|---|---|
| | explicitly provided by PDCCH is not 0b000000 and if PLoffset-RACH or RSRPoffset- | |
| | RACH is configured (e.g., in RA resource configuration and/or in TCI state configuration | |
| | and/or indicated in a DCI format); or | |
| 1> | if the Random Access procedure is initiated by PDCCH order and if the ra-PreambleIndex | |
| | explicitly provided by PDCCH is 0b000000 and if PLoffset-RACH or RSRPoffset-RACH | |
| | is configured (e.g., in RA resource configuration and/or in TCI state configuration and/or | |
| | indicated in a DCI format): | |
| | 2> | assume Msg3 repetition is not applicable for the current Random Access procedure; |
| 1> | else if the BWP selected for Random Access procedure is configured with both set(s) of | |
| | Random Access resources with msg3-Repetitions set to true and set(s) of Random Access | |
| | resources without msg3-Repetitions set to true and the RSRP of the downlink pathloss | |
| | reference is less than rsrp-ThresholdMsg3; or | |
| 1> | if the BWP selected for Random Access procedure is only configured with the set(s) of | |
| | Random Access resources with msg3-Repetitions set to true: | |
| | 2> | assume Msg3 repetition is applicable for the current Random Access procedure. |
| 1> | else: | |
| | 2> | assume Msg3 repetition is not applicable for the current Random Access procedure. |

In one embodiment, for the selection of preamble group, the UE selects either preamble group A or B using a pathloss offset for RA. In one example, the pathloss offset may be configured in RA configuration. In another example, the pathloss offset may be configured in the TCI state configuration. In yet another example, the pathloss offset may be indicated in a DCI format.

In 4-Step RA Procedure,

| 1> | if for the contention-based Random Access preamble selection: | |
|---|---|---|
| | 2> | if at least one of the SSBs with SS-RSRP above rsrp-ThresholdSSB is available: |

| | |
|---|---|
| 3> | select an SSB with SS-RSRP above rsrp-ThresholdSSB. |

| | |
|---|---|
| 2> | else: |

| | |
|---|---|
| 3> | select any SSB. |

| | |
|---|---|
| 2> | if the RA_TYPE is switched from 2-stepRA to 4-stepRA: |

| | |
|---|---|
| 3> | if a Random Access Preambles group was selected during the current Random |
| | Access procedure: |

| | |
|---|---|
| 4> | select the same group of Random Access Preambles as was selected for the 2-step |
| | RA type. |

| | |
|---|---|
| 3> | else: |

| | |
|---|---|
| 4> | if Random Access Preambles group B is configured; and |
| 4> | if the transport block size of the MSGA payload configured in the rach- |
| | ConfigDedicated corresponds to the transport block size of the MSGA payload |
| | associated with Random Access Preambles group B: |

| | |
|---|---|
| 5> | select the Random Access Preambles group B. |

| | |
|---|---|
| 4> | else: |

| | |
|---|---|
| 5> | select the Random Access Preambles group A. |

| | |
|---|---|
| 2> | else if Msg3 buffer is empty: |

| | |
|---|---|
| 3> | if Random Access Preambles group B is configured: |

| | |
|---|---|
| 4> | if the potential Msg3 size (UL data available for transmission plus MAC |
| | subheader(s) and, where required, MAC CEs) is greater than ra-Msg3SizeGroupA |
| | and the pathloss is less than PCMAX (of the Serving Cell performing the Random |
| | Access Procedure) − preambleReceivedTargetPower − msg3-DeltaPreamble − |
| | message PowerOffsetGroupB if PLoffset-RACH is not configured/indicated (e.g., |
| | in RA resource configuration and/or in TCI state configuration and/or indicated in |
| | a DCI format); or |
| 4> | if the potential Msg3 size (UL data available for transmission plus MAC |
| | subheader(s) and, where required, MAC CEs) is greater than ra-Msg3SizeGroupA |
| | and the pathloss is less than PCMAX (of the Serving Cell performing the Random |
| | Access Procedure) − preambleReceivedTargetPower − msg3-DeltaPreamble − |
| | messagePowerOffsetGroupB − (or + in another example) PLoffset-RACH if |
| | PLoffset-RACH is configured in RA resource configuration and/or in TCI state |
| | configuration and/or indicated in a DCI format; or |
| 4> | if the Random Access procedure was initiated for the common control channel |
| | (CCCH) logical channel and the CCCH SDU size plus MAC subheader is greater |
| | than ra-Msg3SizeGroupA: |

| | |
|---|---|
| 5> | select the Random Access Preambles group B. |

| | |
|---|---|
| 4> | else: |

| | |
|---|---|
| 5> | select the Random Access Preambles group A. |

| | |
|---|---|
| 3> | else: |

| | |
|---|---|
| 4> | select the Random Access Preambles group A. |

| | |
|---|---|
| 2> | else (i.e. Msg3 is being retransmitted): |

| | |
|---|---|
| 3> | select the same group of Random Access Preambles as was used for the Random |
| | Access Preamble transmission attempt corresponding to the first transmission of |
| | Msg3. |

| | |
|---|---|
| 2> | select a Random Access Preamble randomly with equal probability from the Random |
| | Access Preambles associated with the selected SSB and the selected Random Access |
| | Preambles group; |
| 2> | set the PREAMBLE_INDEX to the selected Random Access Preamble. |

In 2-Step RA Procedure,

| 1> | if for the contention-based Random Access Preamble selection: | |
|---|---|---|
| | 2> | if at least one of the SSBs with SS-RSRP above msgA-RSRP-ThresholdSSB is available: |

| | |
|---|---|
| 3> | select an SSB with SS-RSRP above msgA-RSRP-ThresholdSSB. |

| | |
|---|---|
| 2> | else: |

| | |
|---|---|
| 3> | select any SSB. |

| | |
|---|---|
| 2> | if contention-free Random Access Resources for 2-step RA type have not been |
| | configured and if Random Access Preambles group has not yet been selected during the |
| | current Random Access procedure: |

| | |
|---|---|
| 3> | if Random Access Preambles group B for 2-step RA type is configured: |

| | |
|---|---|
| 4> | if the potential MSGA payload size (UL data available for transmission plus MAC |
| | subheader and, where required, MAC CEs) is greater than the ra-MsgA- |
| | SizeGroupA and the pathloss is less than PCMAX (of the Serving Cell performing |
| | the Random Access Procedure) − msgA-PreambleReceivedTargetPower − msgA- |
| | DeltaPreamble − messagePowerOffsetGroupB if PLoffset-RACH is not |
| | configured/indicated (e.g., in RA resource configuration and/or in TCI state |
| | configuration and/or indicated in a DCI format); or |
| 4> | if the potential MSGA payload size (UL data available for transmission plus |
| | MAC subheader and, where required, MAC CEs) is greater than the ra-MsgA- |
| | SizeGroupA and the pathloss is less than PCMAX (of the Serving Cell performing |
| | the Random Access Procedure) − msgA-PreambleReceivedTargetPower − msgA- |
| | DeltaPreamble − messagePowerOffsetGroupB − (or + in another example) |
| | PLoffset-RACH if PLoffset-RACH is configured in RA resource configuration |
| | and/or in TCI state configuration and/or indicated in a DCI format; or |
| 4> | if the Random Access procedure was initiated for the CCCH logical channel and |
| | the CCCH SDU size plus MAC subheader is greater than ra-MsgA-SizeGroupA: |

| | |
|---|---|
| 5> | select the Random Access Preambles group B. |

| | |
|---|---|
| 4> | else: |

| | |
|---|---|
| 5> | select the Random Access Preambles group A. |

| | |
|---|---|
| 3> | else: |

| | |
|---|---|
| 4> | select the Random Access Preambles group A. |

In one aspect of power headroom reporting (PHR), a PHR is triggered if the timer phr-ProhibitTimer expires or has expired and the path loss has changed more than phr-Tx-PowerFactorChange dB for at least one RS used as pathloss reference for one activated Serving Cell of any MAC entity of which the active DL BWP is not dormant BWP since the last transmission of a PHR in this MAC entity when the MAC entity has UL resources for new transmission.

In one embodiment, the path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between. In one embodiment, the current pathloss reference for this purpose does not include any pathloss reference configured using pathlossReferenceRS-Pos in 3GPP TS 38.331.

In one embodiment, the UE may receive a configuration for a pathloss offset for a joint TCI state or a UL TCI state for PUSCH or SRS transmission. In one embodiment, the UE may receive a configuration for a pathloss in PHR configuration. If the UE receives such a pathloss configuration, the path loss measured above is derived from the pathloss of DL pathloss RS and the pathloss offset that are associated with the TCI state. If the UE receives a configuration for a PL offset for a joint/UL TCI state, the pathloss of the pathloss reference signal associated with the joint/UL TCI state is based on the measured pathloss of the pathloss reference signal and the PL offset. As an example, the actual pathloss to determine the PHR trigger is the pathloss measured from the DL pathloss RS for a PUSCH transmission plus or minus the pathloss offset that is associated with the TCI state for the PUSCH transmission. If PHR is triggered in this case, type-1 PH is reported in the PHR MAC CE. As another example, the actual pathloss to determine the PHR trigger is the pathloss measured from the DL pathloss RS for a SRS transmission plus or minus the pathloss offset that is associated with the TCI state for the SRS transmission. If PHR is triggered in this case, type-3 PH is reported in the PHR MAC CE.

In one aspect, in single-DCI multi-TRP operation, the network configures a RRC parameter applyIndicatedTCI-state to inform the TCI state to be used for PDCCH reception on a control resource set. The network may configure the parameter with value {1^{st}, 2^{nd}, both, none} to indicate the 1^{st} or the 2^{nd} or both or none of the TCI states associated to a codepoint of the DCI TCI state field. In the case that applyIndicatedTCI-state is configured with value none, the TCI state to be used for PDCCH reception on a control resource set (CORESET) is indicated by MAC CE.

In one embodiment, for CORESET with index 0, and CORESET with index other than 0 and associated at least with CSS sets other than Type3-PDCCH CSS sets, if applyIndicatedTCI-State is configured with value “none”, UE assumes that a DM-RS antenna port for PDCCH receptions in the CORESET is quasi co-located with the one or more DL RS configured by a TCI state indicated by a MAC CE activation command for the CORESET. However, it is not clear which MAC CE is applied to indicate TCI state for the CORESET, as there are two MAC CEs for PDCCH TCI state indication. There two TCI state indications are TCI State Indication for UE-specific PDCCH MAC CE and Enhanced TCI States Indication for UE-specific PDCCH MAC CE.

In one embodiment, TCI State Indication for UE-specific PDCCH MAC CE is used when applyIndicatedTCI-State is configured with value “none” for CORESET with index 0, and for CORESET with index other than 0 and associated at least with CSS sets other than Type3-PDCCH CSS sets.

The TCI State Indication for UE-specific PDCCH MAC CE is identified by a MAC subheader with a logical channel identifier (LCID). It has a fixed size of 16 bits with following fields:
Serving Cell ID: This field indicates the identity of the Serving Cell for which the MAC CE applies. The length of the field is 5 bits. In one example, if the indicated Serving Cell is configured as part of a simultaneousTCI-UpdateList1 or simultaneousTCI-UpdateList2 as specified in 3GPP TS 38.331, this MAC CE applies to all the Serving Cells in the set simultaneousTCI-UpdateList1 or simultaneousTCI-UpdateList2, respectively. In another example, if the indicated Serving Cell is configured as part of a simultaneousU-TCI-UpdateList1 or simultaneousU-TCI-UpdateList2 or simultaneousU-TCI-UpdateList3 or simultaneousU-TCI-UpdateList4 as specified in 3GPP TS 38.331, this MAC CE applies to all the Serving Cells in the set simultaneousU-TCI-UpdateList1 or simultaneousU-TCI-UpdateList2 or simultaneousU-TCI-UpdateList3 or simultaneousU-TCI-UpdateList4, respectively;
CORESET ID: This field indicates a Control Resource Set identified with ControlResourceSetId as specified in 3GPP TS 38.331, for which the TCI State is being indicated. In case the value of the field is 0, the field refers to the Control Resource Set configured by controlResourceSetZero as specified in 3GPP TS 38.331. The length of the field is 4 bits;
TCI State ID: This field indicates the TCI state identified by TCI-StateId as specified in 3GPP TS 38.331 applicable to the Control Resource Set identified by CORESET ID field. If the field of CORESET ID is set to 0, this field indicates a TCI-StateId for a TCI state of the first 64 TCI-states configured by tci-StatesToAddModList in the PDSCH-Config in the active BWP or by dl-OrJoint-TCI-State-ToAddModList in the PDSCH-Config in the active BWP or the reference BWP. If the field of CORESET ID is set to the other value than 0, this field indicates a TCI-StateId configured by tci-StatesPDCCH-ToAddList in the controlResourceSet identified by the indicated CORESET ID. The length of the field is 7 bits.

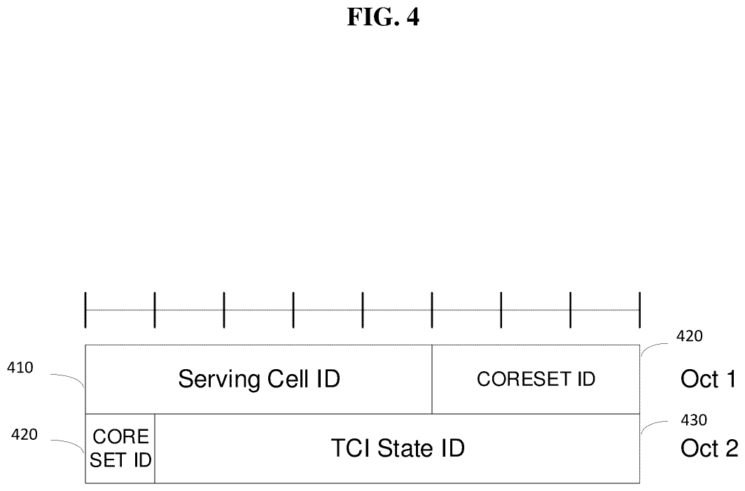

FIG. 4 shows an example of the TCI State Indication for UE-specific PDCCH MAC CE in accordance with an embodiment. The 16-bit MAC CE includes 5 bits of Serving Cell ID (410), 4 bits of CORESET ID (420), and 7 bits of TCI State ID (430).

In one embodiment, Enhanced TCI State Indication for UE-specific PDCCH MAC CE is used when apply IndicatedTCI-State is configured with value “none” for CORESET with index 0, and for CORESET with index other than 0 and associated at least with CSS sets other than Type3-PDCCH CSS sets.

The Enhanced TCI States Indication for UE-specific PDCCH MAC CE is identified by a MAC PDU subheader with an eLCID. It has a fixed size of 24 bits with following fields:
Serving Cell ID: This field indicates the identity of the Serving Cell for which the MAC CE applies. The length of the field is 5 bits. In one example, if the indicated Serving Cell is configured as part of a simultaneousTCI-UpdateList1 or simultaneousTCI-UpdateList2 as specified in 3GPP TS 38.331, this MAC CE applies to all the Serving Cells in the set simultaneousTCI-UpdateList1 or simultaneousTCI-UpdateList2, respectively. In another example, if the indicated Serving Cell is configured as part of a simultaneousU-TCI-UpdateList1 or simultaneousU-TCI-UpdateList2 or simultaneousU-TCI-UpdateList3 or simultaneousU-TCI-UpdateList4 as specified in 3GPP TS 38.331, this MAC CE applies to all the Serving Cells in the set simultaneousU-TCI-UpdateList1 or simultaneousU-TCI-UpdateList2 or simultaneousU-TCI-UpdateList3 or simultaneousU-TCI-UpdateList4, respectively;
CORESET ID: This field indicates a Control Resource Set identified with ControlResourceSetId as specified in 3GPP TS 38.331, for which the TCI State is being indicated. In case the value of the field is 0, the field refers to the Control Resource Set configured by controlResourceSetZero as specified in 3GPP TS 38.331. The length of the field is 4 bits;
TCI state IDi: This field indicates the TCI state identified by TCI-StateId as specified in 3GPP TS 38.331 applicable to the Control Resource Set identified by CORESET ID field. If the field of CORESET ID is set to 0, this field indicates a TCI-StateId for a TCI state configured by dl-OrJoint-TCI-State-ToAddModList in the PDSCH-Config in the active BWP or the reference BWP. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.

In one embodiment, the Enhanced TCI State Indication for UE specific PDCCH MAC CE is not applicable to any of the configured CORESETs in a BWP if the CORESETs are configured with different CORESETPoolindex values in the BWP.

In one embodiment, the Enhanced TCI State Indication for UE specific PDCCH MAC CE is applied only if sfnSchemePdcch is configured.

In one embodiment, the Enhanced TCI State Indication for UE specific PDCCH MAC CE is not applicable to the CORESET configured by controlResourceSetZero if the CORESET is configured with applyIndicatedTCI-State and is associated with the search space configured by pdcch-ConfigSIB1 in MIB, or searchSpaceSIB1, searchSpaceZero, searchSpaceOtherSystemInformation, or pagingSearchSpace in PDCCH-ConfigCommon.

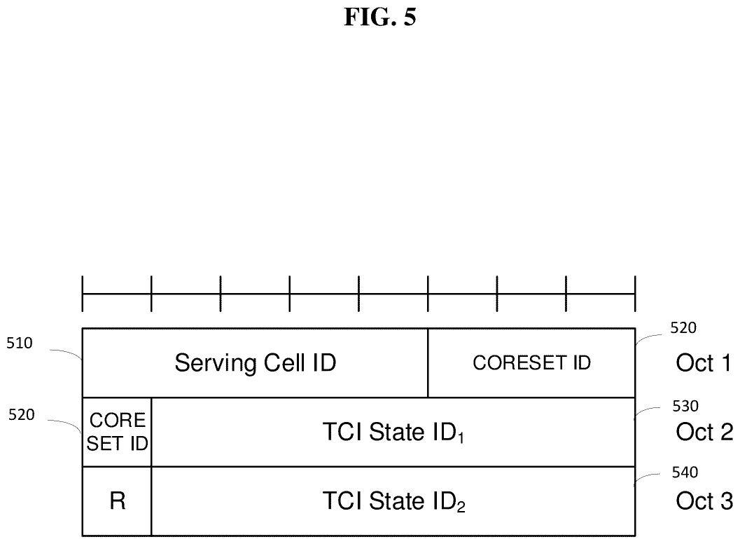

FIG. 5 shows an example of the Enhanced TCI State Indication for UE-specific PDCCH MAC CE in accordance with an embodiment. The 24-bit MAC CE includes 5 bits of Serving Cell ID (510), 4 bits of CORESET ID (520), 7 bits of TCI State ID1 (530) and 7 bits of TCI State ID2 (540).

In one embodiment, for a CORESET with index 0,

| - | if the UE is provided TCI-State and followUnifiedTCI-State for the CORESET, the UE | |
|---|---|---|
| | assumes that a DM-RS antenna port for PDCCH receptions in the CORESET and a DM- | |
| | RS antenna port for PDSCH receptions scheduled by DCI formats provided by PDCCH | |
| | receptions in the CORESET are quasi co-located with the reference signals provided by the | |
| | indicated TCI-State. | |
| - | else if the UE is provided dl-OrJointTCI-StateList and is indicated a first TCI-State and a | |
| | second TCI-State, and apply-IndicatedTCIState for the CORESET | |
| | - | if the CORESET is associated with a Type 0/0A/2-PDCCH CSS set that has search |
| | | space set index 0 |

| | |
|---|---|
| - | if apply-IndicatedTCIState = ‘first’, the UE assumes that a DM-RS antenna port for |
| | PDCCH receptions in the CORESET is quasi co-located with the reference signals |
| | provided by the first TCI-State, |
| - | if apply-IndicatedTCIState = ‘second’, the UE assumes that a DM-RS antenna port |
| | for PDCCH receptions in the CORESET is quasi co-located with the reference |
| | signals provided by the second TCI-State, |
| - | if apply-IndicatedTCIState = ‘none’, the UE assumes that a DM-RS antenna port for |
| | PDCCH receptions in the CORESET is quasi co-located with the one or more DL RS |
| | configured by a TCI state, where the TCI state is indicated by a MAC CE activation |
| | command for the CORESET, if any. |

| | |
|---|---|
| - | else |

| | |
|---|---|
| - | if apply-IndicatedTCIState = ‘first’, the UE assumes that a DM-RS antenna port for |
| | PDCCH receptions in the CORESET is quasi co-located with the reference signals |
| | provided by the first TCI-State, |
| - | if apply-IndicatedTCIState = ‘second’, the UE assumes that a DM-RS antenna port |
| | for PDCCH receptions in the CORESET is quasi co-located with the reference |
| | signals provided by the second TCI-State, |
| - | if apply-IndicatedTCIState = ‘both’, the UE assumes that a DM-RS antenna port for |
| | PDCCH receptions in the CORESET is quasi co-located with the reference signals |
| | provided by the first and the second TCI-State, and apply-IndicatedTCIState = ‘both’ |
| | is applicable to the CORESET only if sfnSchemePDCCH is configured in a serving |
| | cell associated to the CORESET, |
| - | if apply-IndicatedTCIState = ‘none’, the UE assumes that a DM-RS antenna port for |
| | PDCCH receptions in the CORESET is quasi co-located with the one or more DL RS |
| | configured by a TCI state, where the TCI state is indicated by a MAC CE activation |
| | command for the CORESET. |

| - | else, the UE assumes that a DM-RS antenna port for PDCCH receptions in the CORESET | |
|---|---|---|
| | is quasi co-located with | |
| | - | the one or more DL RS configured by a TCI state, where the TCI state is indicated by a |
| | | MAC CE activation command for the CORESET, if any, or |
| | - | a SS/PBCH block the UE identified during a most recent random access procedure not |

initiated by a PDCCH order that triggers a contention-free random access procedure, if no
MAC CE activation command indicating a TCI state for the CORESET is received after
the most recent random access procedure, or a SS/PBCH block the UE identified during a
most recent configured grant PUSCH transmission as described in 3GPP TS 38.321 clause
19.

In one embodiment, if the UE is provided dl-OrJointTCI-StateList and is indicated a first TCI-State and a second TCI-State, and is provided apply-IndicatedTCIState for a CORESET, other than a CORESET with index 0,

| - | if the CORESET is associated only with USS sets and/or Type3-PDCCH CSS sets | |
|---|---|---|
| | - | if apply-IndicatedTCIState = ‘first’, the UE assumes that a DM-RS antenna port for |
| | | PDCCH receptions in the CORESET is quasi co-located with the reference signals |
| | | provided by the first TCI-State |
| | - | if apply-IndicatedTCIState = ‘second’, the UE assumes that a DM-RS antenna port |
| | | for PDCCH receptions in the CORESET is quasi co-located with the reference |
| | | signals provided by the second TCI-State |
| | - | if apply-IndicatedTCIState = ‘both’, the UE assumes that a DM-RS antenna port for |
| | | PDCCH receptions in the CORESET is quasi co-located with the reference signals |
| | | provided by the first TCI-State and the second TCI-State, and apply- |
| | | IndicatedTCIState = ‘both’ is applicable to the CORESET only if sfnSchemePDCCH |
| | | is configured in a serving cell associated to the CORESET |
| - | if the CORESET is associated at least with CSS sets other than Type3-PDCCH CSS sets, | |
| | - | if apply-IndicatedTCIState = ‘first’, the UE assumes that a DM-RS antenna port for |
| | | PDCCH receptions in the CORESET is quasi co-located with the reference signals |
| | | provided by the first TCI-State |
| | - | if apply-IndicatedTCIState = ‘second’, the UE assumes that a DM-RS antenna port |
| | | for PDCCH receptions in the CORESET is quasi co-located with the reference |
| | | signals provided by the second TCI-State |
| | - | if apply-IndicatedTCIState = ‘both’, the UE assumes that a DM-RS antenna port for |
| | | PDCCH receptions in the CORESET is quasi co-located with the reference signals |
| | | provided by the first TCI-State and the second TCI-State, and apply- |
| | | IndicatedTCIState = ‘both’ is applicable to the CORESET only if sfnSchemePDCCH |
| | | is configured in a serving cell associated to the CORESET |
| | - | if apply-IndicatedTCIState = ‘none’, the UE assumes that a DM-RS antenna port for |
| | | PDCCH receptions in the CORESET is quasi co-located with the one or more DL RS |
| | | configured by a TCI state indicated by a MAC CE activation command for the |
| | | CORESET. |

In one embodiment, for two CORESETs associated with two search space sets configured with the same searchSpaceLinkingId, they could be configured with ‘apply-IndicatedTCIState=‘first’ and apply-IndicatedTCIState=‘second’, respectively.

In one embodiment, for the RRC parameter apply-IndicatedTCIState, the field apply IndicatedTCI-State indicates, for PDCCH reception on this CORESET, if the UE applies the first, the second, both or none “indicated” DL only TCI or joint TCI as specified in 3GPP TS 38.213, clause 10.1. applyIndicatedTCI-State may be set to ‘both’ only if sfnSchemePDCCH is configured in the serving cell, or alternatively, applyIndicatedTCI-State may be set to ‘both’ only if sfnSchemePDCCH is configured in the serving cell associated to this CORESET.

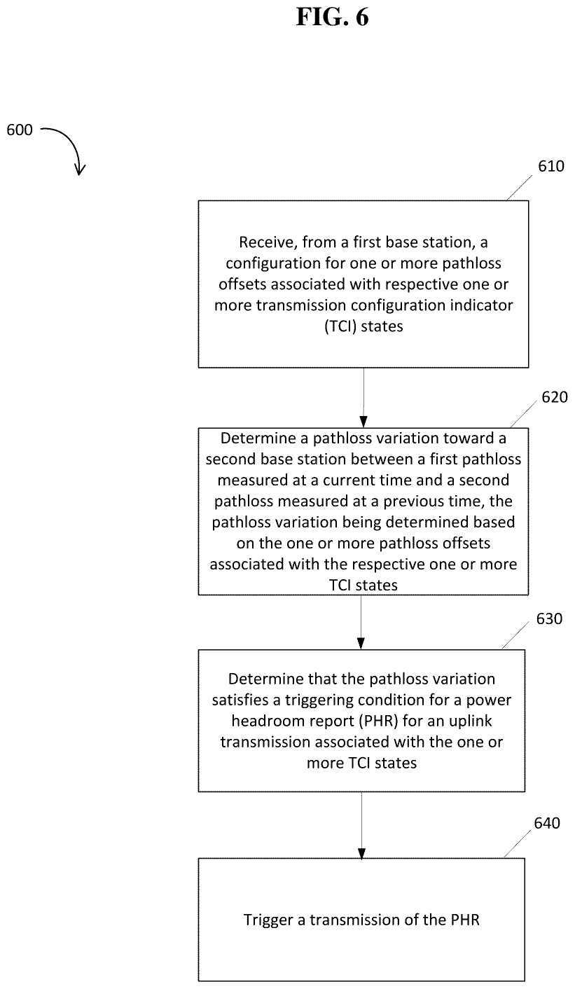

FIG. 6 shows an example process 600 for using a pathloss offset between the DL pathloss RS from first base station and the actual pathloss for UL transmission to a base station when reporting power headroom in accordance with an embodiment. For explanatory and illustration purposes, the example processes 400 may be performed by a UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods

Referring to FIG. 6, the process 600 may begin in operation 610. In operation 610, a UE (e.g., a processor of the UE) receives from a first base station a configuration for one or more pathloss offsets associated with respective one or more transmission configuration indicator (TCI) state. In one embodiment, the first base station may be a macro BS/TRP in an asymmetric DL/UL BS/TRP deployment scenario where were the UE receives DL transmissions from the macro BS/TRP and sends UL transmissions to a micro UL-only BS/TRP.

In operation 620, the UE determines a pathloss variation toward a second base station between a first pathloss measured at a current time and a second pathloss measured at a previous time, where the pathloss variation is determined based on the one or more pathloss offsets associated with the respective one or more TCI states. In one embodiment, the second base station may be the micro UL-only BS/TRP in the asymmetric DL/UL BS/TRP deployment scenario.

In one embodiment, to determine the pathloss variation toward the second base station, the UE determines a first pathloss on a first downlink reference signal associated with a first TCI state from the first base station at the current time. The UE also determines a second pathloss on a second downlink reference signal associated with a second TCI state from the first base station at the previous time. The UE then determines the pathloss variation as the difference between the first pathloss and the second pathloss.

In one embodiment, to determine the first pathloss, the UE sets the first pathloss to a measured pathloss on the first downlink reference signal plus or minus the pathloss offset associated with the first TCI state.

In one embodiment, to determine the second pathloss, the UE sets the second pathloss to a measured pathloss on the second downlink reference signal plus or minus the pathloss offset associated with the second TCI state.

In operation 630, the UE determines that the pathloss variation satisfies a triggering condition for a power headroom report (PHR) for an uplink transmission associated with the one or more TCI states.

In one embodiment, the UE receives from the first base station a configuration for a pathloss variation threshold and a PHR timer. The UE determines that the pathloss variation satisfies the triggering condition when the pathloss variation exceeds the pathloss variation threshold and the time elapsed since the last transmission of the PHR exceeds the PHR timer.

In operation 640, the UE triggers a transmission of the PHR.

The disclosure presents various embodiments for a UE to use a pathloss offset in an asymmetric DL/UL BS/TRP deployment scenario such as when the UE receives DL transmissions from a macro BS/TRP and transmits UL to a micro UL-only BS/TRP. In one aspect, the UE may use the pathloss offset when reporting power headroom for uplink transmissions such as PUSCH or SRS. In one aspect, the UE may use the pathloss offset when performing a random access procedure, such as when determining the UL power for PRACH transmission. In one aspect, the network may indicate to the UE one or more TCI states to be applied for PDCCH reception on a CORESET. The UE may receive the indication of the TCI states and the pathloss offset associated with the TCI states in a PDDCH MAC CE. Advantageously, the disclosed techniques for using the pathloss offset in the asymmetric DL/UL BS/TRP deployment scenario improve UL throughput by facilitating accurate calculation of the pathloss associated with the micro nodes.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) in a wireless network, the UE comprising:
a processor configured to:
receive, from a first base station, a configuration for one or more pathloss offsets associated with respective one or more transmission configuration indicator (TCI) states;
determine a pathloss variation toward a second base station between a first pathloss measured at a current time and a second pathloss measured at a previous time, the pathloss variation being determined based on the one or more pathloss offsets associated with the respective one or more TCI states;
determine that the pathloss variation satisfies a triggering condition for a power headroom report (PHR) for an uplink transmission associated with the one or more TCI states; and
trigger a transmission of the PHR.

2. The UE of claim 1, wherein to determine the pathloss variation toward the second base station, the processor is configured to:
determine a first pathloss on a first downlink reference signal associated with a first TCI state from the first base station at the current time;
determine a second pathloss on a second downlink reference signal associated with a second TCI state from the first base station at the previous time; and
determine the pathloss variation as the difference between the first pathloss and the second pathloss.

3. The UE of claim 2, wherein to determine the first pathloss, the processor is configured to:
set the first pathloss to a measured pathloss on the first downlink reference signal minus the pathloss offset associated with the first TCI state; or
set the first pathloss to the measured pathloss on the first downlink reference signal plus the pathloss offset associated with the first TCI state.

4. The UE of claim 2, wherein the first downlink reference signal and the second downlink reference signal comprise one of:
a same downlink reference signal; or
different downlink reference signals.

5. The UE of claim 2, wherein to determine the second pathloss, the processor is configured to:
set the second pathloss to a measured pathloss on the second downlink reference signal minus the pathloss offset associated with the second TCI state; or
set the second pathloss to the measured pathloss on the second downlink reference signal plus the pathloss offset associated with the second TCI state.

6. The UE of claim 1, wherein to determine that the pathloss variation satisfies the triggering condition, the processor is configured to:
receive, from the first base station, a configuration for a pathloss variation threshold and a PHR timer;
determine that the pathloss variation exceeds the pathloss variation threshold; and
determine that an elapsed time since a last transmission of the PHR exceeds the PHR timer.

7. The UE of claim 1, wherein the uplink transmission comprises a physical uplink shared channel (PUSCH) transmission or a sounding reference signal (SRS) transmission to the second base station.

8. The UE of claim 1, wherein the processor is further configured to:
receive, from the first base station, a physical downlink control channel (PDCCH) that orders a physical random access channel (PRACH) transmission, wherein the PDCCH includes an indication of a pathloss offset associated with a TCI state; and
determine a transmission power for a PRACH transmission to the second base station based on the pathloss offset.

9. The UE of claim 8, wherein the PRACH transmission comprises a contention free random access (CFRA) to the second base station.

10. The UE of claim 1, wherein the one or more TCI states comprise a first TCI state and a second TCI state, and wherein the processor is further configured to:
receive, from the first base station, an indication to use both the first TCI state and the second TCI state to receive a physical downlink control channel (PDCCH) on a control resource set (CORESET) when a single frequency network scheme is configured for the first base station.

11. A method performed by a user equipment (UE) in a wireless network, the method comprising:
receiving, from a first base station, a configuration for one or more pathloss offsets associated with respective one or more transmission configuration indicator (TCI) states;
determining a pathloss variation toward a second base station between a first pathloss measured at a current time and a second pathloss measured at a previous time, the pathloss variation being determined based on the one or more pathloss offsets associated with the respective one or more TCI states;
determining that the pathloss variation satisfies a triggering condition for a power headroom report (PHR) for an uplink transmission associated with the one or more TCI states; and
triggering a transmission of the PHR.

12. The method of claim 11, wherein determining the pathloss variation toward the second base station comprises:
determining a first pathloss on a first downlink reference signal associated with a first TCI state from the first base station at the current time;
determining a second pathloss on a second downlink reference signal associated with a second TCI state from the first base station at the previous time; and
determining the pathloss variation as the difference between the first pathloss and the second pathloss.

13. The method of claim 12, wherein determining the first pathloss comprises:
setting the first pathloss to a measured pathloss on the first downlink reference signal minus the pathloss offset associated with the first TCI state; or
setting the first pathloss to the measured pathloss on the first downlink reference signal plus the pathloss offset associated with the first TCI state.

14. The method of claim 12, wherein the first downlink reference signal and the second downlink reference signal comprise one of:
a same downlink reference signal; or
different downlink reference signals.

15. The method of claim 12, wherein determining the second pathloss comprises:
setting the second pathloss to a measured pathloss on the second downlink reference signal minus the pathloss offset associated with the second TCI state; or
setting the second pathloss to the measured pathloss on the second downlink reference signal plus the pathloss offset associated with the second TCI state.

16. The method of claim 11, wherein determining that the pathloss variation satisfies the triggering condition comprises:
receiving, from the first base station, a configuration for a pathloss variation threshold and a PHR timer;
determining the pathloss variation exceeds the pathloss variation threshold; and
determining that an elapsed time since a last transmission of the PHR exceeds the PHR timer.

17. The method of claim 11, wherein the uplink transmission comprises a physical uplink shared channel (PUSCH) transmission or a sounding reference signal (SRS) transmission to the second base station.

18. The method of claim 11, further comprising:
receiving, from the first base station, a physical downlink control channel (PDCCH) that orders a physical random access channel (PRACH) transmission, wherein the PDCCH includes an indication of a pathloss offset associated with a TCI state; and
determining a transmission power for a PRACH transmission to the second base station based on the pathloss offset.

19. The method of claim 18, wherein the PRACH transmission comprises a contention free random access (CFRA) to the second base station.

20. The method of claim 11, wherein the one or more TCI states comprise a first TCI state and a second TCI state, and wherein the method further comprises:
receiving, from the first base station, an indication to use both the first TCI state and the second TCI state to receive a physical downlink control channel (PDCCH) on a control resource set (CORESET) when a single frequency network scheme is configured for the first base station.
